(19) United States
(12) Patent Application Publication
(10) Pub. No.: US 2006/0206610 A1
(43) Pub. Date: Sep. 14, 2006

(54) Method, system and apparatus for location-aware content push service and location-based dynamic attachment

(76) Inventors: Yibei Ling, Belle Mead, NJ (US); Wai Chen, Parsippany, NJ (US); Onur Altintas, Kawasaki (JP)

Correspondence Address: TELCORDIA TECHNOLOGIES, INC., ONE TELCORDIA DRIVE 5G116, PISCATAWAY, NJ, 08854-4157, US

(21) Appl. No.: 11/076,485

(22) Filed: Mar. 9, 2005

(51) Int. Cl. G06F 17/00; G06F 7/00; G06F 15/16; G06F 15/173

(52) U.S. Cl. 709/226; 707/104.1; 709/203

(57) ABSTRACT

A method and system for providing location-aware and location-based content services. The system preferably comprises an overlay service network that includes a plurality of information gateway servers. A mobile client uses the servers in the overlay service network to request and receive information. The particular server used by the mobile client is selected based on the geo-location of the mobile client. The method comprises partitioning a geographic area into a plurality of sub-areas and associating resources to the sub-areas based on the location of mobile units within a sub-area.

### CROSS-REFERENCE TO RELATED APPLICATIONS

This application is related to commonly assigned U.S. patent application Ser. No. ______, (Attorney Docket No. TELCORDIA App. No. 1537/TELCOR 1.0-007), filed on even-date herewith and entitled “Method, Apparatus and System For a Location Based Resource Locator,” the disclosure of which is hereby incorporated herein by reference.

### BACKGROUND OF THE INVENTION

The Internet is a global collection of networks that provide ubiquitous access to various types of information and allows users to communicate over expansive geographic areas, i.e., the geography of the earth. In that regard, the Internet provides a convenient means for users to access, gather and share information. Such information is typically stored on a collection of geographically scattered servers, which provide services to other machines, such as personal computers or clients and other servers, which comprise the Internet. Typically, the Internet is accessed from a web client application running on a personal computer, laptop, personal digital assistant or home appliance at a fixed location. A fixed location may comprise, for example, a user's home or office. More and more, however, there is a demand for content information residing on the Internet in mobile applications.

In particular, an emerging need of intelligent transport systems is the ability to access location-based or location-aware information in a mobile environment, such as telematic applications, roadside emergency assistance and a variety of front-seat and rear-seat applications. Telematic generally refers to onboard vehicle capability to exchange information to and from mobile platforms. Users are typically more and more demanding the capability to be able to access information while on the go, such as from an automobile or other transportation systems. Such transportation systems are generally considered as a mobile platform. Applications for such mobile platforms are evolving from applications in fixed location platforms. By fixed location platforms, we generally refer to a non-mobile environment, where devices typically communicate via a wired connection.

These mobile platforms typically require seamless integration of existing applications while also require addressing problems associated with mobility and heterogeneous networks. Existing applications typically include web access, reading and sending e-mails, viewing movies and listening to music. In addition, location-aware or location-based applications such as emergency notification, navigation, real-time road condition reports and location-aware advertisement insertion exists for fixed platforms and need to be supported by mobile platforms.

A typical problem associated with providing information to a mobile device is that web pages and other files are maintained by a collection of geographically scattered servers, as discussed above. Among these servers are a group of servers generally referred to as gateway servers, which are typically considered as network points that provide access or act as “gateways” between different networks. For example, an Internet Service Provider (ISP) typically provides customer access to the Internet through one or more gateway servers. Each gateway server is assigned an Internet Protocol (IP) address and each machine on the network, including servers, is also provided an IP address. Each IP address serves to uniquely identify each machine, i.e., servers. To make content searching easier and more intelligible for humans, URLs (uniform resource locators) such as www.telcordia.com, for example, are used to locate content on the web. Behind every URL, however, is an IP address or collection of IP addresses that uniquely identify one or more servers on the Internet. For example, the URL www.cnn.com is served by twelve servers. Typically, the content information is stored in a memory on the machine or may be located in a database or memory that is accessible by the machine.

In contrast to a fixed-location request for content information, when a mobile user requests information residing on the Internet, the location of the user and the location of the content information may play a role in determining how quickly the information gets routed to the user, the type of information the user may need and the costs associated with providing the requested content information to the user. For example, a user driving down a California highway may desire information specifically relating to his/her locality, e.g. the highway being traveled or a nearby town. Such information may comprise a local traffic condition, a choice of local restaurants or a local weather condition. A request for such local information by a mobile user typically results in an untimely provision of information of relatively low value to the user. That is, typically, the requested content information is retrieved from a memory or database without regard to the location of the user or the content information. This results in a delay between when the information is requested and provided. The delay may result in the information being provided to the user after the user has left the locality. Thus, the information would then be of relatively little value. In addition, the cost of providing the information to the user will typically increase in relation to an increase in the distance between the location of the user and the location of the content information.

Thus, there is a need for improving the way in which a mobile user accesses and is provided with content information residing on the Internet.

### SUMMARY OF THE INVENTION

An aspect of the present invention is a system for providing location-based services. The system preferably comprises a plurality of gateway servers distributed over a geographic area such that each gateway server is responsible for providing services within pre-determined areas of the geographic area and a plurality of mobile devices that are connectable to the plurality of gateway servers based on the location of the plurality of mobile devices within the pre-determined areas.

Further in accordance with this aspect of the present invention, the pre-determined areas are preferably formed by partitioning the geographic area into non-overlapping sub-rectangular areas. It is also preferable that each of the plurality of gateway servers is associated with a non-overlapping sub-rectangular area.

Further still, each server may include a cache memory for storing content information.

Further in accordance with this aspect of the present invention, the plurality of mobile devices may be selected from the group consisting of a cellular telephone, a laptop computer, a pager and a personal digital assistant.

Further in accordance with this aspect of the present invention, each of the gateway servers are desirably coupled to one or more sources for content information associated with the location-based services. It is also preferable that each of the gateway servers automatically deliver content information from one of the content sources to the mobile devices within the pre-determined area that the server is responsible for. Further still, it is preferable that the content information that is delivered includes location information.

Further in accordance with this aspect of the present invention, it is desirable that each mobile device that receives content information determines whether to accept the content information based on the geographic location of the mobile device. The geographic location information preferably comprises position information obtained from a global positioning system or satellite.

In another aspect, the present invention is a method for providing information to a client device over a communication network. The method preferably comprises partitioning a geographic area covered by the network into a plurality of pre-determined service areas and associating at least one service server with a pre-determined service area. The method further preferably comprises directing information to or from the client device through the service server associated with the pre-determined service area in which the client device is currently located.

Further in accordance with the method, partitioning preferably comprises segmenting the geographic area into a plurality of non-overlapping rectangular service areas.

Further in accordance with this aspect of the present invention, the method further preferably comprises associating a service server with each of the plurality of non-overlapping rectangular service areas.

Further in accordance with the method, directing preferably comprises associating a primary service server with the client device based on a residence area associated with the client device. It is also desirable that directing comprises associating a secondary service server with the client device when the client device is not located within the residence area.

Further in accordance with this aspect of the present invention, directing may desirably comprise routing information destined for the client device through the secondary service server when the client device is not located within the service area.

Further in accordance with this aspect of the present invention, the method may further desirably comprise providing information to the client device based on a pre-determined service area in which the client device is currently located.

Further still in accordance with this aspect of the present invention, the method may further desirably comprise associating a plurality of content servers with the plurality of pre-determined service areas based on the location of the content servers.

The method may also further desirably comprise associating each of the pre-determined service with a geographic area.

Further in accordance with this aspect of the present invention, the method may further preferably comprise providing at least one server in the network separate from the service servers for initiating sending content information to the client device.

Further still in accordance with this aspect of the present invention, the method may further desirably comprise inhibiting access to the content information based on the location of the client device.

### BRIEF DESCRIPTION OF THE DRAWINGS

FIG. 1 illustratively depicts a system in accordance with an aspect of the present invention.

FIG. 2 illustratively depicts a system in accordance with an aspect of the present invention.

FIG. 3 illustratively depicts partitioning of location-based resource management in accordance with an aspect of the present invention.

FIG. 4 illustratively depicts a flow diagram for a location-based dynamic service in accordance with an aspect of the present invention.

FIG. 5 illustratively depicts a flow diagram for location-based dynamic service attachment in accordance with an aspect of the present invention.

FIG. 6 illustratively depicts a flow sequence for a server-initiated content push service in accordance with an aspect of the present invention.

FIG. 7 illustratively depicts a flow sequence of a client-poll-based content push in accordance with an aspect of the present invention.

FIG. 8 illustratively depicts a flow-sequence of a client-initiated content push service in accordance with an aspect of the present invention.

FIG. 9 illustratively depicts an example of a user interface in accordance with an aspect of the present invention.

### DETAILED DESCRIPTION

Additional details associated with some aspects of the present application are described in commonly assigned U.S. patent application Ser. No. ______ (TELCORDIA App. No. 1537/TELCOR 1.0-007) filed on even-date herewith and entitled “Method, Apparatus and System For A Location-Based Uniform Resource Locator,” the disclosure of which is hereby incorporated herein by reference.

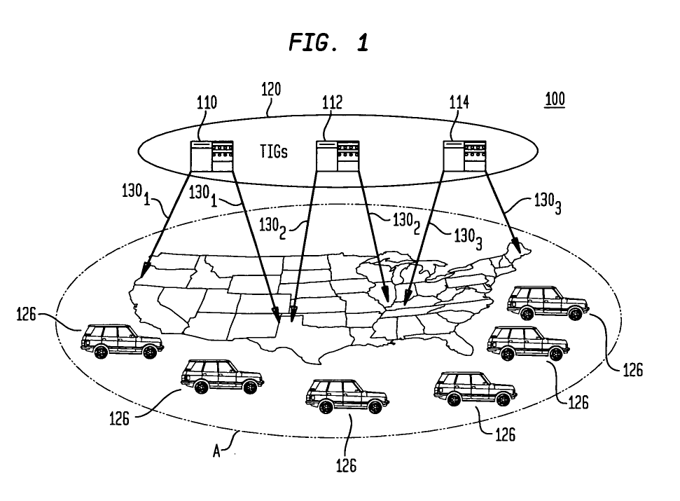

FIG. 1 illustratively depicts a system in accordance with an aspect of the present invention. As shown, the system 100 includes servers, 110, 112 and 114 that comprise an overlay service network 120. The servers 110, 112 and 114 are used to manage mobility and content delivery for mobile devices in the geographic area illustratively depicted as A. Geographic area A is shown as illustratively comprising the United States, but may comprise any other country, region or geographic locality. The mobile unit is illustratively depicted as an automobile 126. As the automobile 126 traverses the geographic A, it may request or receive content information through the servers 110, 112 or 114. The server that is used to provide the content information is preferably determined based on the location of the mobile unit 126. For example, as the mobile unit 126 moves within the sub-area denoted by arrows 130₁, the server 110 provides gateway access to the mobile unit 126. As the mobile unit enters the sub-area 2 serviced by server 112 (see arrows 130₂), access and content delivery is transferred from server 110 to server 112. Thus, while in sub-area 2, server 112 manages content delivery and requests to and from the mobile unit 126. As the mobile unit 126 enters into sub-area 3 content delivery and requests are then managed by server 114. Sub-area 3 is denoted by the arrows 130₃. Although FIG. 1 includes only three servers associated with three geographic sub-areas, the geographic area may be sub-divided into less or more than three sub-areas based on a variety of factors including business needs, such as customer demand, investment costs, terrain, which service provider controls a particular geographic area or sub-area, or the type of systems or servers and their associated loading capacity. As is discussed in further detail below, each of the servers 110, 112 and 114 are preferably connected to an existing network, e.g., Internet or a private network, so that information residing on the existing networks may be provided for the mobile unit as the mobile unit traverses a geographic area.

The servers 110, 112 or 114 preferably act as cache servers of content sources, as well as gateways between the mobile units and existing or third party networks. The capability of the servers allow content information from content servers, such as a server associated with http://www.cnn.com, for example, to reduce the latency associated with content retrieval.

As discussed above, the mobile units communicate with the servers, which are deployed as part of an overlay service network. The mobile unit preferably uses a location-based resource locator to identify the appropriate search server in the overlay service network that a request from a mobile unit should be directed to. If content requested by a mobile unit is cached in the overlay service network, a connecting gateway server is able to identify a server in the overlay service network, retrieve the contents from such server and then forward the content to the mobile unit. If the requested content is not cached in the overlay service network, then the gateway server sends a request to a content server in, for example, the existing network or third party network. The information is then routed from the content source in the existing or third party network to the mobile unit. By caching the content information in the overlay network latency in servicing requests by mobile units may be reduced. The content information may remain cached for a predetermined amount of time or based on the load of the caching server.

The mobile unit 126 may comprise an automobile as shown. The mobile unit may also comprise a cellular telephone, a laptop computer, a personal digital assistant (PDA) or any device that includes a microprocessor that can access the overlay service network while moving within a geographic area or region and that can determine its geo-location or acquire geo-location information.

The mobile unit, in general, preferably includes a browser, a database, a software program that provides a proxy service and the capability to communicate with a global positioning system. Additional details associated with the preferred functional capabilities of the mobile units are discussed in detail in the aforementioned U.S. app. Ser. No. ______ (Telcordia App. No. 1537/TELCOR 1.0-007). The browser, in general, is an application program program that allows a user to look at and interact with information on the World Wide Web or Internet. The browser therefore preferably provides an interface that allows a user to request content information that may be located on the Internet, an existing network or third party network. The browser also includes an interface to the software program that provides a proxy service. The proxy service software program functions as a location resolver, i.e., translating the present geographic location of the mobile terminal to an IP address of a server in the overlay service network. The GPS block updates the real-time, geographic location or position information associated with the mobile device and provides that information to the software program.

As a general matter, a mobile unit may comprise a device that is equipped with a memory for storing the instructions associated with the browser software and proxy service software and a processor for executing those instructions, as well as an antenna and associated circuitry for receiving and processing GPS-related information. The gateway servers may be implemented on any commercially available server platform including Microsoft, Novell or Hewlett Packard platforms.

As discussed above, the overlay service network comprises a plurality of geographically scattered servers that are connected to an existing network and provides content delivery and mobility management. We generally refer to the servers as information gateway servers. Each information gateway server has autonomy in managing and hosting highly localized content such as local traffic, hotel and restaurant information. In addition, each information gateway server is preferably flexible and adapted to share information with the other information gateway servers. The use of an overlay service network advantageously allows the various aspects of the present invention to be implemented in any carrier and existing network infrastructure. In addition, the system load may be shared across multiple information gateway servers. The system also allows for an improvement in reliability and resilience to transient failures that may occur.

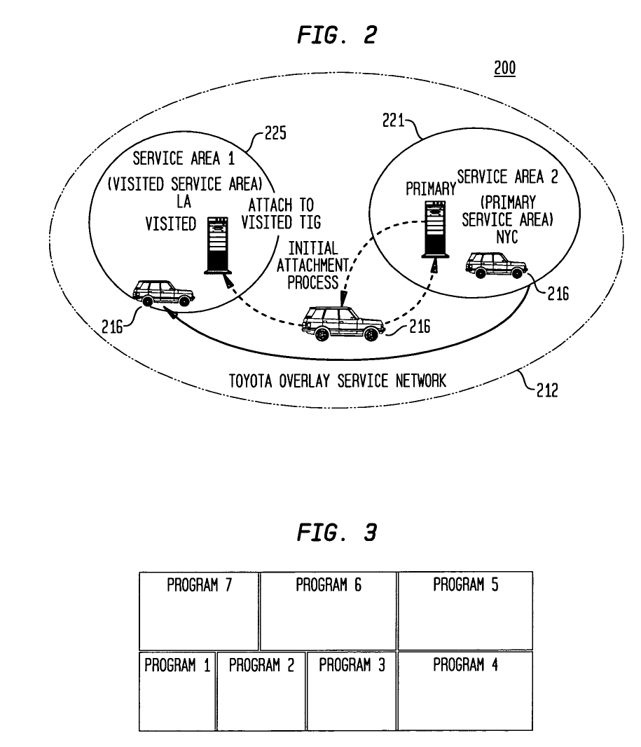

Turning now to FIG. 2, a system and associated flow diagram is depicted in accordance with an aspect of the present invention. For the purposes of this illustrative example, the system includes a pair of information gateway servers 204, 208 that comprise an overlay service network 212 for managing the mobility and delivery of content information for mobile unit 216. Within the overlay service network 212 are two distinct service areas 221 (Service Area 1) and 225 (Service Area 2). Service Area 1 comprises the primary service area associated with the mobile unit 216. The primary service area is associated with the primary server 204. Preferably, the primary server 204 and primary service area are determined or selected based on the residence area of the user associated with the mobile unit. For example, if the user resided in New York City, then the primary server comprises a server associated with managing that user's mobility, content request and content delivery within that service area, e.g., New York City.

The primary server 204 stores profile or preference information associated with users registered as residents in the primary service area 221. The primary server 204 also stores up-to-date geographic information associated with the distribution of the other information gateway servers, e.g., server 208, that comprise the overlay service network 212. Thus, when a customer moves out of his/her primary residence area, the location of the customer is sent back to his/her primary information gateway server, which in turn returns an address, preferably an Internet Protocol (IP) address, of an information gateway server associated with a geographic area in which the customer is currently located and visiting.

In particular, as the mobile unit 216 travels from the primary service area 221 to a visited service area 225, the mobile unit 216 transmits its location (228) to the primary server 204. The primary server 204 then transmits the address associated with a gateway information server, such as server 208, based on the location of the mobile unit 216. The transmission of the address of server 208 is illustratively depicted using arrow 232. Once the mobile unit 216 receives the address information associated with the server 208 for the visited service area, i.e., Service Area 2, the mobile unit then attaches to server 208 for requesting or receiving content information while in Service Area 2. Service Area 1 and 2 are preferably overlapping to some extent so that the user may be handed off from one service area to the other transparently. Thus, as the user changes service areas, the user's service is not disrupted. In other words, any content that is being delivered is not disrupted because of the change in service areas. Although FIG. 2 illustrates two separate service areas associated with New York City and Los Angeles, it should be understood that the service areas may comprise more than two geographic areas that may be partitioned based on cost, user demand and other factors discussed above.

The overlay service network and servers associated therewith preferably operate at the upper layers of the 7-layer Open System Interconnection reference model (OSI model) such that management of user mobility and content information may be done transparently to the other layers that comprise the OSI reference model. In accordance with the OSI reference model, layer 1 is the physical layer, layer 2 is the data link layer, layer 3 is the network layer, layer 4 is the transport layer, layer 5 is the section layer, layer 6 is the presentation layer and layer 7 is the application layer. Accordingly, the details associated with handing off a mobile unit between cells of a cellular network or between different cellular networks, e.g., from a WLAN to a cellular network or from a cellular network to a satellite network, may be done transparently to the overlay service network since such activity is already managed by the lower layers of the protocol stack. For example, in the illustrative example of FIG. 2, as the user moves from Service Area 1 to Service Area 2, the user may be handed off between cell towers, roam from a home cellular network to a foreign cellular network. In this regard, the user may advantageously receive content information that is location-based or location-aware without being required to be at a specific location in the geographic area. That is, location-based or location-aware services typically require that the user be within a specified locality a particular cell tower or building. This aspect of the present invention also advantageously allows users outside a particular geographic area to be prevented from receiving until they enter that area.

In addition, partitioning of a geographic area into sub-areas and associating an information gateway server with each sub-area allows a change in the geographic distribution of the information gateways in a single location to be automatically configured in the primary server and transparently communicated to the mobile unit. In this way, the partitioning of the geographic area can be done dynamically and transparently to each user.

In that regard, FIG. 3 illustratively depicts scheme for managing location-based resource information. The particular scheme illustrated in FIG. 3 is based on a Voroni view, although other schemes may be used. In accordance with FIG. 3, each information gateway server may be associated with a rectangular region that comprises a service area. In other words, an entire area is partitioned into a plurality of non-overlapping sub-rectangular areas and resources are associated with each sub-rectangular area. When a customer enters a location demarked by a sub-rectangular area, requests to resources associated with that sub-rectangular area are automatically initiated. Area partitioning and resource association is typically business and customer dependent.

Table 1 illustrates a database scheme used in accordance with an aspect of the present invention. The fields and data identified in Table 1 represent the type of information used by the information gateway servers to manage mobility and deliver content information in accordance with a further aspect of the present invention.

TABLE 1

| Field Name | Data Type |
|---|---|
| ProgramID | Number |
| URL | Text |
| AccessPriority | Number |
| Longitude1 | Double |
| Latitude1 | Double |
| Longitude2 | Double |
| Latitude2 | Double |
| MediaType | Number |
| Title | Text |
| Content | Text |
| BandwidthCapacity | Number |
| TimeDuring | Number |
| Status | Text |
| ServerName | Text |

As Table 1 shows, the database may include a field named Program ID that is associated with a number data type. The Program ID field identifies the sub-rectangular areas or, in general, sub-areas that the geographic region is partitioned into. Another field included in Table 1 is a URL (Uniform Resource Locator) that is associated with a text data type. The data type associated with the URL field preferably comprises a location-based URL as described above. The Access Priority field is associated with a number data type.

The database schema also includes longitudinal and latitudinal fields which are represented by the Field Names Longitude 1, Latitude 1, Longitude 2 and Latitude 2. Each of these longitudinal and latitudinal fields are associated with the longitude and latitude coordinates in decimal form. Where a Voroni view is used, each rectangular may be represented by its upper left-most point and lower right-most point, which allows for efficient implementation in a relational database.

Table 1 also includes fields for the Media Type and Bandwidth Capacity associated with the delivery network. The Media Type is associated with a number data type information, which preferably represents optical, wire or wireless type media resources. The Bandwidth Capacity field is also associated with a number, which provides the bandwidth available for delivery the content information.

Table 1 also includes entries for title and content. The title is associated with text data type and will generally refer to the title of the content that is being provided. The content field is also associated with a textural data type and will generally refer to the type of information being delivered. Such information may comprise text, video, web pages, audio or any combination of the foregoing.

The last two fields in Table 1 are labeled Status and Server Name and are associated with textural data types. The Server Name comprises the name of the gateway server that is servicing a mobile unit at it's request.

In practice, an information gateway server periodically receives GPS location information from each mobile that it is currently servicing. The server checks the location information it receives against the latitudinal and longitudinal information associated with the mobile unit and stored in its memory. As long as there is a match between the latest position information it receives and the position information stored in its local database, the information gateway server provides requested information and initiates transmittal of other data based on the information shown on Table 1 and stored in the database. If there is not a match between the position of the mobile and the location information stored in the server's memory, the server then determines the appropriate sub-area that the mobile unit is currently located in and uses the resources associated with that sub-area to then service the mobile unit.

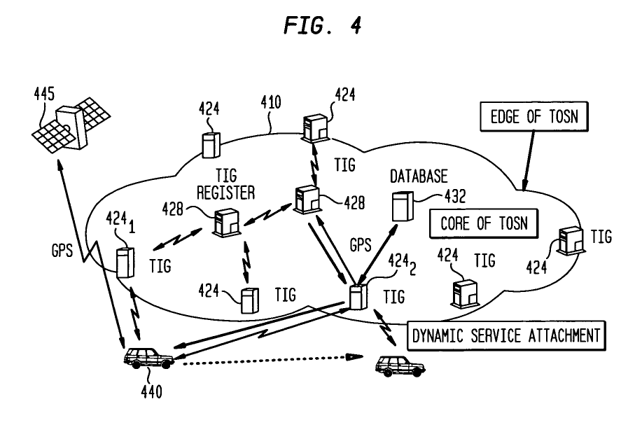

As best seen in FIG. 4, an overlay network may be considered as comprising an edge 410 and a core 420. The edge 410 preferably comprises a plurality of geographically disbursed information gateway 424. The core comprises one or more information gateway registers 428 and at least one database 432. The servers that comprise the core of the overlay service network provide functionalities such as user profile management, authentication, authorization and accounting. The core servers also preferably perform the function of tracking or maintaining the geographic distribution of the information gateways that comprise the edge of the overlay service network. Preferably, each information gateway 424 registers with an information gateway register 428. Such registration may include information such as the servers' IP address and geographic area of responsibility.

In addition, the core network 420 preferably includes the database 432, which houses or stores the information described above and discussed in relation to Table 1. Any topological change in the geographic distribution in the information gateway 424 is captured by the information gateway register 428, which then stores the topological change and routes such changes to a database, e.g., database 432. Topological changes may then be distributed to the information gateway 424 and to the mobile unit, if desired.

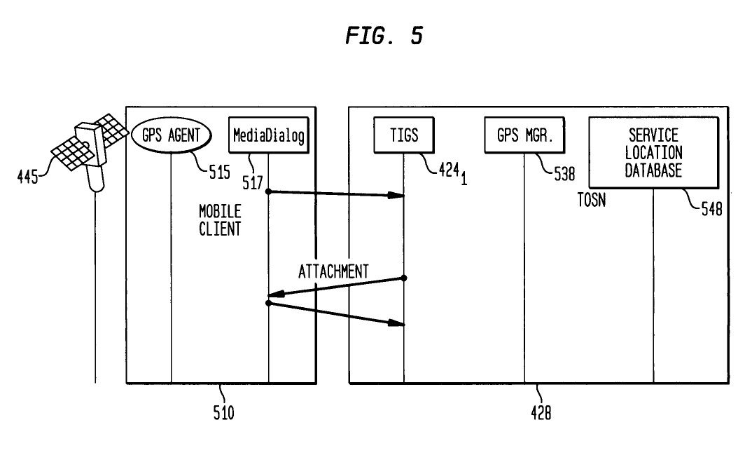

With reference to FIGS. 4 and 5, location-based dynamic service attachment of a mobile unit traversing a geographical area will now be described. Mobile unit 440 includes a mobile client 510. Mobile client 510 is used to receive and store mobile information received from a global positioning system, which is illustrated and depicted as satellite 445. The mobile unit 440 preferably includes the necessary antennas, associated circuitry and software necessary to receive location information from the satellite 445. As shown in FIG. 5, the mobile client 510 preferably includes a GPS agent 515 that processes the received location information. The GPS agent 515 preferably comprises software and associated memory. The mobile client 510 preferably includes a media dialog component 517 that processes information related to location received from the GPS agent 515. The media dialog component 517 preferably comprises software that associates location information with an IP address of an information gateway server 424 that the mobile client 440 is currently using to attach to the overlay service network based on the current location of the mobile unit 440. With reference to FIG. 4, this information gateway server is designated as 424₁. The information gateway server 424₁ may then access an information gateway register 428 to determine the next information gateway server that should take over content delivery and mobility management associated with the mobile unit 440. The information gateway register 428 as illustrated in FIG. 5 may include a GPS manager 538 and a service location database 548. The GPS manager 538 preferably performs the function of determining the next service area that the mobile area will most likely be entering. Such a determination may be implemented using software and may be based on location information received from the mobile unit 440 over a period of time. That is, the GPS location information may be used to predict the next sub-rectangular Voroni area that the mobile unit 440 will most likely enter. The GPS manager 538 may then access a service location database to determine the IP address of the information gateway server responsible for the next sub-area that the mobile unit 440 will be entering. For purposes of this example, the next information gateway server is illustratively depicted as server 424₂. The information gateway register then returns the address associated with the next information gateway server to be used to server 424₁. The server 424₁ then provides the address information to the mobile client 510 of the mobile unit 440. The mobile unit 440 may then connect to information gateway server 424₂ using the address information it receives.

In addition, the information gateway register 428 may communicate with the information gateway server 424₂ through the core network so that authentication, authorization and accounting may take place. Once the information gateway server 424₂ receives proper authentication and authorization, it may then also broadcast location-based or location-aware information to the mobile unit 440.

In this regard, an aspect of the present invention is the provision of a location-aware content push service. In accordance with this aspect of the present invention, the content push service is characterized by its automatic delivery (time-sensitivity), content organization and user profiles. In particular, content is desirably provided to a user based on the geo-location of a user's mobile unit and not on the particular network that the user may be attached to or whether the user is proximate with a particular building or structure. In accordance with this aspect of the present invention, a content location-aware push service also desirably separates the push initiator from the push content and is carrier independent. In a highly mobile environment such as a vehicle, information will typically be location-sensitive. For example, real-time highway traffic in Los Angeles is not meaningful to drivers in New Jersey. Because of the separation of the push initiator from the push content and the additional benefit of carrier-independence, a user may then receive information based on its current real-time geo-location.

As previously discussed, an aspect of the present invention is the provision of a location-aware content push service. In this regard, a location-aware push initiator allows location-sensitive content information to be pushed to customers in specified geographic areas at pre-determined time intervals, while inhibiting access to such content information to customers that are outside of the specified area. Support of a location-aware content push service typically requires knowledge of a client's, mobile unit's or user's location. In addition, the manner in which content is pushed to the client may have an impact on the carrier network.

In accordance with this aspect of the present invention, a push content message comprises three elements: push content source, push content area and content duration. The push content source, as is discussed in further detail below, is functionally different and separate from the push initiator. In accordance with this aspect of the present invention, the separation of the push content source and push initiator represents a departure from traditional content push services in which the push initiator and push content source or provider typically comprise the same functional element or physical structure. The content duration parameter generally refers to the time-to-live or lifetime of the content and is indicative of how long the content may be used. The content push area parameter refers to the target area to which the push content will be directed. The data structures illustrated in Table 1 may comprise the format of a push content message.

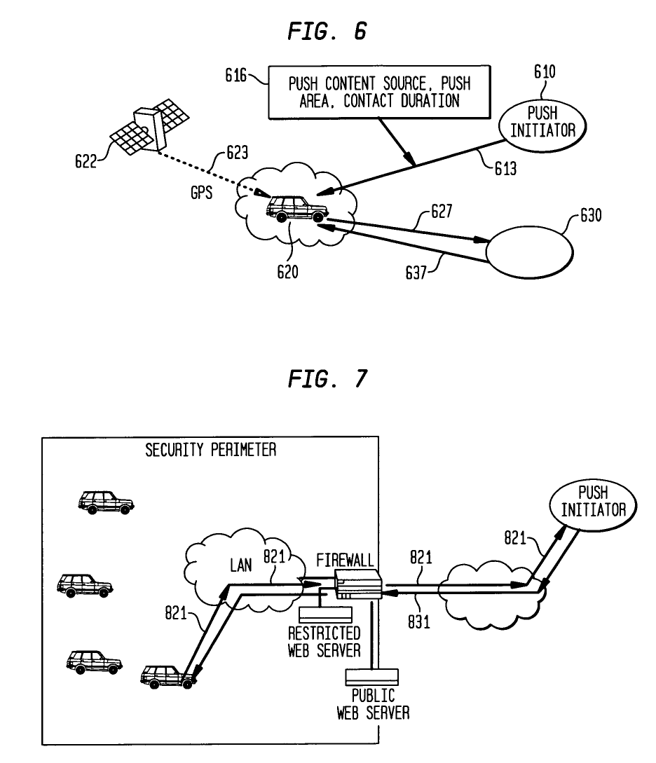

Location-based content push services may be considered to include two variations: (1) server-initiated content push; and (2) client-initiated content push. In a server-initiated content push, a push initiator pushes content to all the clients in a particular geographic area. Content messages may take the form shown in Table 1. In this regard, the area may be expressed by the upper left-most point and the lower right-most point if a Voroni view is used. Upon receipt of the content push message, each client checks the message against their current location. If the current location of a client falls within a sub-rectangular area specified in the push message, the client may then send a request to the content source specified in the push message and thereafter receive the content message. FIG. 6 illustrates a flow diagram associated with a server-initiated push service.

As shown in FIG. 6, a push initiator 610 preferably broadcasts message to the clients registered on an overlay service network. Upon receipt of the push message (line 613), which includes at least information identifying a push content source, a push area and content duration as illustrated in block 616, the mobile unit 620 compares information identifying the push area with its own geo-location information. Such geo-location information may be received from a satellite 622 via a link 623. If the mobile unit 620 is located within the push area, the mobile unit 620 then sends a message (line 627) to the push content source 630 as identified by the push message 616. The push content source 630 then sends the pushed content information to the mobile unit 620, as shown via line 637. In addition to using the push area information contained in the push message 616 to determine whether or not to request the pushed content information, the mobile unit may also use the content duration information in the push message 616 in making such a determination. In particular, if a content duration specifies a particular time period and the mobile unit determines that the time period has either passed or not yet come, then it would not request the push content information as such information would not be expected to be available.

A server-initiated content push may be desirable in some circumstances because such a content push may be initiated only when needed and without the need to know the location of each client. Further, this type of service may be carrier dependent and limited in a practical setting where security of the network takes precedence. For example, if a network provider included a fire wall to prevent unwanted messages or spam from getting to clients on its network, the push messages initiated by the push initiator may be blocked by the fire wall.

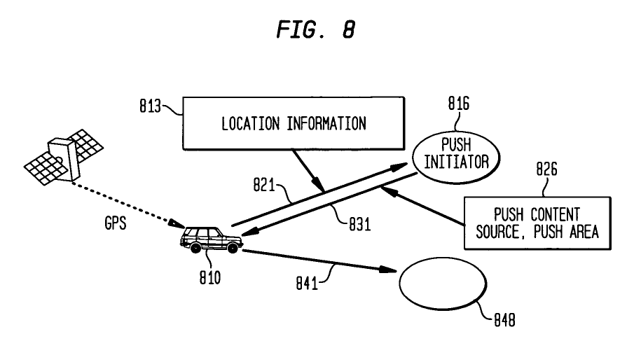

Security concerns, however, may be addressed by using a client-initiated content push service. In such a service, each client or host periodically sends its location to a push service. Upon receipt of such location information, the push server checks the location of each client and returns push content information via the connection established by each client if the location of a client falls within the target area. The client may the initiate a request for content information through a content source specified by the push server. A flow diagram of a client-initiated content push service is illustrated in FIGS. 7 and 8.

With reference to FIGS. 7 and 8, the mobile unit 810 initiates the process by sending its location information 813 to the push initiator 816. (Line 821) As best seen in FIG. 7, line 821 will typically traverse a low Local Area Network (LAN), which includes a security parameter defined by a fire wall server. Upon receipt of the location information 813 from the mobile unit 810, the push initiator 816 then sends the push content message 826 to the mobile unit via link 831. As seen in FIG. 7, link 831 preferably traverses the internet and a local area network similar to link 821. The mobile unit 810 then uses the push content message 826 to issue a push content request (link 841) to the content source at 848 identified by the push content message 826. Periodic transmission of location information by the mobile unit could be costly. Therefore, the transmission of such information may be done periodically and implemented in accordance with the system architecture. A client-initiated content push service is carrier independent. Both the client-initiated content push service and a server initiated push service may be employed in a complimentary fashion in a network and may be customized to suit different network environments.

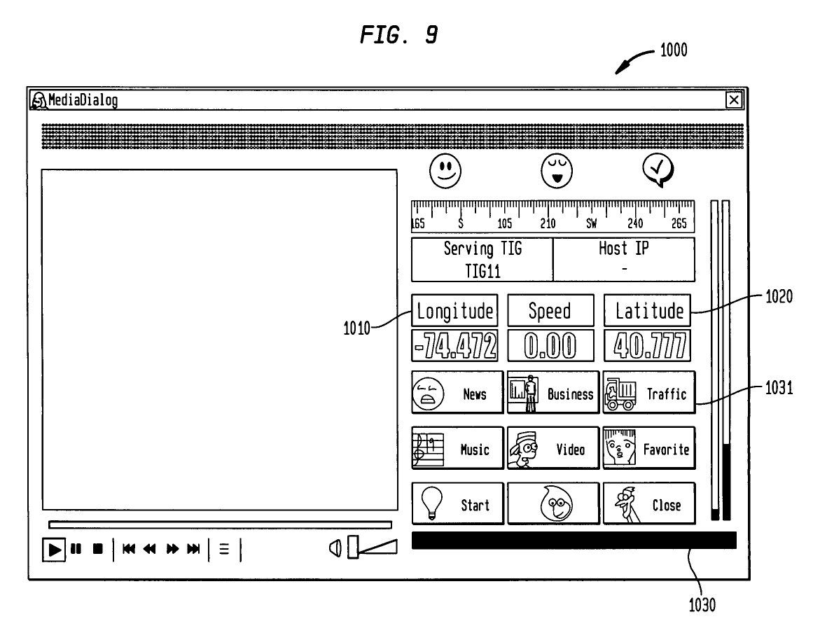

Turning now to FIG. 9, there is illustrated a Graphic Network User (GNU) system that may be employed in a mobile unit. The GNU of FIG. 10 comprises the user interface in a prototype system, which we called MediaDialog. As seen in FIG. 10, a user interface 1000 may display longitude 1010 and latitude 1020 information. In addition, the interface 1000 may desirably include one or more touch sensitive buttons 1030. Each of these buttons may be used to request location-based information from the mobile unit in accordance with the foregoing discretions. For example, by selecting the traffic button 1031, a user may receive information on traffic conditions based on the longitude and latitude information indicated in areas 1010 and 1020. In addition, buttons are provided for requesting music, video, news and business information. In general, any information that is currently available over the World Wide Web may be accessed via the user interface.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A system for providing location-based services, comprising:
a plurality of gateway servers distributed over a geographic area such that each gateway server is responsible for providing service within pre-determined areas of the geographic area; and
a plurality of mobile devices that are connectable to the plurality of gateway servers based on the location within the pre-determined areas of the plurality of mobile devices.

2. The system of claim 1, wherein the pre-determined areas are formed by partitioning the geographic area into non-overlapping sub-rectangular areas.

3. The system of claim 2, wherein each of the plurality of gateway servers is associated with a non-overlapping sub-rectangular area.

4. The system of claim 3, wherein each gateway server includes a memory cache for storing content information.

5. The system of claim 1, wherein the plurality of mobile devices are selected from the group consisting of a cellular telephone, a laptop computer, a pager and a personal digital assistant.

6. The system of claim 1, wherein each of the gateway servers are coupled to one or more sources for content information associated with the location-based services.

7. The system of claim 6, wherein each of the gateway servers automatically deliver content information from one of the content sources to the mobile devices within the pre-determined area.

8. The system of claim 7, wherein the content information that is delivered includes location information.

9. The system of claim 7, wherein each mobile device that receives the content information determines whether to accept the content information based on the geographic location of the mobile device.

10. A method for providing information to a client device over a communication network, comprising:
partitioning a geographic area covered by the network into a plurality of pre-determined services area;
associating at least one service server with each of the pre-determined service areas; and
directing information to and from the client device through the service server associated with the pre-determined service area in which the client device is currently located.

11. The method of claim 10, wherein partitioning comprises segmenting the area in a plurality of non-overlapping rectangular service areas.

12. The method of claim 11, further comprising associating a service server with each of the plurality of non-overlapping rectangular service areas.

13. The method of claim 10, wherein directing comprises associating a primary service server with the client device based on a residence area associated with the client device.

14. The method of claim 13, wherein directing comprises associating a secondary service server with the client device when the client device is not located within the residence area.

15. The method of claim 14, wherein directing comprises routing information destined for the client device through the secondary service server when the client device is not located within the residence area.

16. The method of claim 10, further comprising providing information to the client device based on a pre-determined service area in which the client device is currently located.

17. The method of claim 10, further comprising associating a plurality of content servers with the plurality of pre-determined service areas based on the location of the content servers.

18. The method of claim 10, further comprising associating each of the pre-determined service areas with a geographic area.

19. The method of claim 10, further comprising providing at least one server in the network separate from the service servers for sending content information to the client device.

20. The method of claim 18, comprising inhibiting access to the content information based on the location of the client device.
